(19) United States
(12) Patent Application Publication
(10) Pub. No.: US 2018/0004369 A1
(43) Pub. Date: Jan. 4, 2018

(54) COMPUTER IMPLEMENTED METHOD AND COMPUTER DEVICE

(71) Applicant: KING.COM LIMITED, St. Julians (MT)

(72) Inventor: Halldor Bjarnason, Stockholm (SE)

(21) Appl. No.: 15/472,757

(22) Filed: Mar. 29, 2017

(30) Foreign Application Priority Data
Mar. 29, 2016 (GB) 1605216.9

(51) Int. Cl. G06F 3/0482; A63F 13/30; G06F 3/0485; A63F 13/25; G06F 3/0488

(52) U.S. Cl. CPC G06F 3/0482; G06F 3/0485; A63F 13/25; A63F 13/30; G06F 3/0488

(57) ABSTRACT

A computer device comprises at least one memory configured to store computer code and a display. A processor causes the display to display at least a part of a list of different game options which when selected allows a game to be played. Responsive to input from a user to scroll through the list, the display will display one of the different game options in a game option area which is at a predetermined position with a larger area than at least one other game option area associated with a respective different one of the game options.

### CROSS-REFERENCE TO RELATED APPLICATIONS

This application is based on, and claims priority to, Great Britain Application No. GB 1605216.9, filed Mar. 29, 2016, the entire contents of which being fully incorporated herein by reference.

### FIELD OF THE INVENTION

Some embodiments relate to a computer-implemented method of determining similarity of two or more users and a computer device adapted therefor.

The embodiments may have particular, but not exclusive application in the field of computer implemented applications including for example games, and computing devices therefor.

### BACKGROUND OF THE INVENTION

In the field of computer-implemented games, there are many technical challenges facing the designer of such games when considering how the user interface is to be controlled in the context of computer devices available to play the game.

There are a number of different situations where it is desirable to match two or more people. By way of example, dating websites are provided to allow the matching of two individuals using a matching algorithm. Gaming websites may also want to provide one or more opponents to a given player.

One technical challenge associated with computer-implemented games is how to provide an environment where two or more users can play together or interact. It is technically challenging to generate a social aspect to a game where a user is playing for short amounts of time and not always at a same time as other players.

### SUMMARY OF THE INVENTION

According to an aspect, there is provided a computer device comprising: at least one memory configured to store computer code; a display; at least one processor configured to execute said stored computer code to cause said display to display part of a list of different game options for a computer implemented game, each game option when selected allowing a game to be played; and a user interface configured to receive input from a user to scroll through said list displayed on said display, wherein, responsive to said user input scrolling through said list of different game options, the at least one processor is configured to cause the display to display one of said different game options in a game option area which is at a predetermined position with respect to said display with a larger area than at least one other game option area associated with a respective different one of said different game options.

The game options may comprise game levels.

When said one of the game options is at the predetermined position with said larger area and input is received from said user interface, the at least one processor may be is configured to cause said one game option to be selected.

When a game option is displayed at the game option area with the larger area, the at least one processor may be configured to cause the display to display additional information as compared to said at least one other game option area.

The additional information may comprise one or more of: information about said game option; and an area selectable using the user interface, said selectable area when selected causing the game option to be played.

The at least one processor may be configured to control the display such that a game option area increases as the input from the user interface causes that game option area to moves to the predetermined position with respect to the display.

The at least one processor may be configured to control the display such that a game option area decreases in size as the input from the user interface causes that game option area to move away from the predetermined position with respect to the display.

Each of said game option areas which is fully displayed on said display may be of at least a minimum size.

The at least one processor may be configured to control the display such that a game option area increases from the minimum size as the input from the user interface causes that game option area to moves to the predetermined position with respect to the display.

The at least one processor may be configured to control the display such that said predetermined position is at a top region of said display.

The at least one processor may be configured to display at least one other game option other than the last game option and the last game option, said last game option when fully displayed on said display having a size between said minimum size and a size which is defined by a size of said game object area less the larger area.

The at least one processor may be configured to display said list extending in a first extent of said display, said user input configured to receive said input from a user to scroll along said first extent through said list displayed on said display.

The display may be configured to display a subset of said different game options at one time.

According to another aspect, there is provided a computer implemented method for displaying, on a display, computer game graphics for a computer implemented game, comprising executing on one or more processors the steps of: causing said display to display part of a list of different game options for a computer implemented game, each game option when selected allowing a game to be played; receiving input from a user via a user interface to scroll through said list displayed on said display; and responsive to said user input scrolling through said list of different game options, causing the display to display one of said different game options in a game option area which is at a predetermined position with respect to said display with a larger area than at least one other game option area associated with a respective different one of said different game options.

The game options may comprise game levels.

When said one of the game options is at the predetermined position with said larger area and input is received from said user interface, the method may comprise causing said one game option to be selected.

When a game option is displayed at the game option area with the larger area, the method may comprise causing the display to display additional information as compared to said at least one other game option area.

The additional information may comprise one or more of: information about said game option; and an area selectable using the user interface, said selectable area when selected causing the game option to be played.

The method may comprise controlling the display such that a game option area increases as the input from the user interface causes that game option area to moves to the predetermined position with respect to the display.

The method may comprise controlling the display such that a game option area decreases in size as the input from the user interface causes that game option area to move away from the predetermined position with respect to the display.

Each of said game option areas which is fully displayed on said display may be of at least a minimum size.

The method may comprise controlling the display such that a game option area increases from the minimum size as the input from the user interface causes that game option area to move to the predetermined position with respect to the display.

The method may comprise controlling the display such that said predetermined position is at a top region of said display.

The method may comprise causing the display of at least one other game option other than the last game option and the last game option, said last game option when fully displayed on said display having a size between said minimum size and a size which is defined by a size of said game object area less the larger area.

The method may comprise causing the display of said list extending in a first extent of said display and receiving input from the user interface causing scrolling along said first extent through said list displayed on said display.

The method may comprise displaying a subset of said different game options at one time.

According to another aspect, there is provided a non-transitory computer readable medium encoded with instructions for controlling a computer device having a display, in which the instructions when executed on a processor enable the processor to execute the steps of: causing said display to display part of a list of different game options for a computer implemented game, each game option when selected allowing a game to be played; receiving input from a user via a user interface to scroll through said list displayed on said display; and responsive to said user input scrolling through said list of different game options, causing the display to display one of said different game options in a game option area which is at a predetermined position with respect to said display with a larger area than at least one other game option area associated with a respective different one of said different game options.

According to another aspect there is provided a computer device adapted to play a computer game, at least one processor, at least one memory, a display, a user interface and computer code stored in said memory, and in which the computer code generates computer game graphics for display on the display, and in which the at least one processor is configured to execute steps to: cause the display to display a question and to display a plurality of different answer options; receive an input from the user interface, said input selecting one of said plurality of different answer options; compare a value associated with said selected answer option with a value of a selected answer options associated with a different user; determine based on said comparison a similarity between selected answer options; and cause said display to display information about said similarity and information about said different user.

It should be appreciated the information about similarity can be information about how similar the answers are and/or how different the answers are. The similarity information may comprise match information. The similarity information may be a measure of difference.

In some embodiments, each answer option is associated with a descriptor value. In some embodiments the descriptor value comprises an integer. In other embodiments, the descriptor value may not be integer.

In some embodiments, a difference between two descriptor values is a measure of a similarity between the two answers.

In some embodiments, the at least one processor is configured to cause the display to display a set of questions and the respective plurality of different answer options for each question of the set.

It should be appreciated that the number of questions in the set may be any suitable number of questions. In some embodiments, the number of questions may be between 10 and 20. However in other embodiments there may be more questions than 20 or less questions than 10.

The question and the answer options may be displayed at the same time on the display or may be displayed one after the other.

In some embodiments, the steps of comparing a value associated with said selected answer option with a value of a selected answer option associated with a different user and determine based on said comparison a similarity between selected answer options is determined for each question and used to determine information about said similarity for said set of questions.

In some embodiments, one or more questions of said set may be associated with a weight. In some embodiments, each question of said set may be associated with a weight. In some embodiments, a respective weight of a question is taken into account when determining a similarity for said set of questions.

In some embodiments, the determining of information about said similarity for said set of questions may be configured to determine an arithmetic mean or a geometric mean.

In some embodiments said information about said similarity may comprises a percentage value.

In some embodiments information related to said set of questions may be stored. The information may be stored in the memory of the device and/or in at least one database on a server side.

In some embodiments, the set of questions is associated with a seed. Information about said seed may be stored in the memory of the device and/or in at least one database on the server side.

In some embodiments, information relating to set of questions and/or seed may be transmitted from the user device to a server for storing in one or more databases. In some embodiments, this may be performed as part of the process to synchronise user related data which is stored at one or more databases at the server side.

In some embodiments, the steps performed by the processor may be repeated for at least one other set of questions. Information about said similarity may be determined using information from the plurality of different sets of questions.

In some embodiments the steps performed by the processor may be performed for a plurality of different users such that similarity information for a plurality of different users with respect to the user of the game is determined.

In some embodiments, the plurality of different users are ordered in dependence on the similarity information.

In some embodiments, the similarity information and identity information is displayed for a respective different user, one at a time on said display.

In some embodiments, the similarity information and identity information is displayed for a plurality of different users in a list.

In some embodiments a subset of one or more of said different users is selected and the information about the similarity and the information about said different one or more users of said subset is displayed.

In some embodiments, the subset may comprise y different users, where y is an integer of one or more and said y different users satisfy one or more criteria. For example the criteria may select the users with the greatest match value. Alternatively or additionally, one or more criteria may comprise one or more of age, location, gender and/or the like.

There may be any suitable number of different answer options. For example the number of answer options may between 3 and 5. However it should be appreciated that in some embodiments the number of question may be less than 3 or greater than 5.

According to an aspect there is provided a computer device adapted to play a computer game, at least one processor, at least one memory, a display, a user interface and computer code stored in said memory, and in which the computer code generates computer game graphics for display on the display, and in which the at least one processor is configured to execute steps to: cause the display to display a question and to display a plurality of different answer options; receive an input from the user interface, said input selecting one of said plurality of different answer options assuming a first criteria; compare a value associated with said selected answer option with a correct answer based on said first criteria; determine based on said comparison a number of moves; and cause said display to display a representation of a user on a game board, said game board comprising a plurality of tiles and a position of said representation on a respective one of said tiles of said game board being dependent on said number of moves.

In some embodiments, the first criteria may comprise a most popular answer option selected by a plurality of different users. The first criteria may alternatively comprise a least popular answer option, an answer option selected by another particular use, a random selection or any other suitable criteria.

In some embodiments, each answer option is associated with a descriptor value. In some embodiments the descriptor value comprises an integer. In other embodiments, the descriptor value may not be integer.

In some embodiments, a difference between two descriptor values is used to control a number of moves.

According to an aspect there is provided a computer device adapted to play a computer game, at least one processor, at least one memory, a display, a user interface and computer code stored in said memory, and in which the computer code generates computer game graphics for display on the display, and in which the at least one processor is configured to execute steps to: cause said display to display part of a list of different game options, each game option when selected allowing a game to be played; receive input from said user interface to scroll through said list; and cause the display to display a game option area at a predetermined position with respect to said display with a larger area than at least one other game option area.

The game option may comprise a game level.

The game option with the larger area may display additional information as compared to at least one other game option area.

The additional information may comprise one or more of information about said game option and an area selectable using the user interface, said selectable area when selected allowing the game option to be played.

The at least one processor may be configured to control the display such that a game option area increases as it moves to the predetermined position. The at least one processor may be configured to control the display option area to decrease in size as the next game option moves to the predetermined position.

According to an aspect there is provided a computer apparatus adapted to select a set of questions for a computer game, said apparatus comprising at least one processor, at least one memory, an interface and computer code stored in said memory, wherein said memory is configured to store a plurality of questions and for each question a plurality of different answer options, wherein the at least one processor is configured to execute steps to: select a subset of questions using a ‘seed, wherein a same subset of questions is selected for a given seed.

The seed may be a random seed. The computer apparatus may be configured to generate a random seed. The random seed may be generated by a random or pseudo random number generator.

The memory may store for each question category information. The memory may alternatively or additionally store further information for each question. In some embodiments, the further information may comprise date information. For example the date information may comprise import information. The import date may for example relate to the date the question was added to the apparatus or imported into memory.

The computer apparatus may be configured to apply at least one filter to said plurality of questions to provide a filtered set of questions from which said subset of questions is selected.

The filter may be a category filter.

The filtered set of questions may only comprise questions of said plurality of questions which are associated with said category.

The selecting may comprise use said seed to identify questions which satisfy a criteria with respect to said further information. The criteria may be a date or date range.

The seed may identify a seed interval. The seed interval may be between a minimum and maximum seed number. The seed interval may correspond to a date or date range.

In some embodiments, the questions are first filtered and then the seed is used. In other embodiments, the seed is used and the resulting questions are filtered. It should be appreciated that in some embodiments only the filtering may be provided. In other embodiments only the use of seed in the selection may be provided.

The at least one processor may be configured to arranged to arrange candidate questions in deterministic sequence. In some embodiments, the candidate questions may be those satisfying at least one filter and/or satisfying a criteria with respect to said further information.

In some embodiments, the seed may be used to select said question from said deterministic sequence of questions. In some embodiments, the seed is used to generate a sequence of numbers, each number corresponding to a respective question in said deterministic sequence. In some embodiments, each number corresponds to the relative position of a question in the deterministic sequence of questions.

The computer apparatus may be a server side device or server side system or a computer device on which the game is played.

A computer system comprising: at least one database, said database storing information associated with a plurality of different players of a computer game, said information comprising for each of a first player and a second player: information identifying the respective player; information indicating with which other players said respective player is connected; information indicating which set or sets of questions associated with said game have been answered by said respective player and associated answer information; at least one processor configured to determine for said first and second player, if they are connected, if the first and second players have answered one or more of the same sets of questions, and if so to compare the associated answers to determine a similarity between the answers, and to provide information about said similarity to at least one of the first and second players.

In some embodiments, each set of set of question may be associated with a seed and said determining if said first and second players have answered one or more of the same sets of questions may comprise comparing seed information associated the first player with seed information associated with the second player.

In some embodiments, the first and second players may have become connected in response to playing a game comprising answering the same set of questions. In that case the determining will comprise determining if there is at least one further same set of questions.

A computer implemented method for displaying, on a display, computer game graphics for a game, comprising executing on one or more processors the steps of: causing the display to display a question and to display a plurality of different answer options; receiving an input from the user interface, said input selecting one of said plurality of different answer options; comparing a value associated with said selected answer option with a value of a selected answer options associated with a different user; determining based on said comparison a similarity between selected answer options; and causing said display to display information about said similarity and information about said different user.

A computer implemented method for displaying, on a display, computer game graphics for a game, comprising executing on one or more processors the steps of: causing the display to display a question and to display a plurality of different answer options; receiving an input from the user interface, said input selecting one of said plurality of different answer options assuming a first criteria; comparing a value associated with said selected answer option with a correct answer based on said first criteria; determining based on said comparison a number of moves; and causing said display to display a representation of a user on a game board, said game board comprising a plurality of tiles and a position of said representation on a respective one of said tiles of said game board being dependent on said number of moves.

A computer implemented method for displaying, on a display, computer game graphics for a game, comprising executing on one or more processors the steps of: causing said display to display part of a list of different game options, each game option when selected allowing a game to be played; receive input from said user interface to scroll through said list; and causing the display to display a game option area at a predetermined position with respect to said display with a larger area than at least one other game option area.

A computer implemented method, comprising executing on one or more processors the steps of: selecting a subset of questions using a ‘seed, wherein a same subset of questions is selected for a given seed.

A computer implemented method, comprising executing on one or more processors the steps of: determining for a first and second player, if they are connected, if the first and second players have answered one or more of the same sets of questions: if so comparing the associated answers to determine a similarity between the answers; and providing information about said similarity to at least one of the first and second players

A non-transitory computer readable medium encoded with instructions for controlling a computer, in which the instructions when executed on a processor enable the processor to execute the steps of any of the above methods.

### DESCRIPTION OF THE DRAWINGS

Embodiments of the invention will now be described by way of the accompanying drawings in which:

FIG. 1 shows an example system in which some embodiments may be provided;

FIG. 2 shows an example user device in which some embodiments may be provided;

FIG. 3 shows a method flow for the selection of questions;

FIGS. 4a and 4b shows a method flow between two players;

FIGS. 5a to 5f show displayed images of as a user scrolls through a list of levels;

FIG. 6 shows a flow chart for determining match information;

FIG. 7 schematically shows an example game board displayed by a display in some embodiments;

FIG. 8 shows a method for determining a number of moves which will be moved after each question;

FIG. 9 shows a method for providing more detail match information for two users;

FIG. 10 shows an example of the data which stored for each question.

### DESCRIPTION OF PREFERRED EMBODIMENTS

The terms user and player are used interchangeably throughout this document and no specific meaning is intended using one or the other unless the context suggests otherwise.

In the following description of various implementations of the invention, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

A person skilled in the art will realise that the different approaches to implementation of the computer implemented game is not exhaustive, what is described herein are certain preferred embodiments. It is possible to implement embodiments in a number of variations without departing from the spirit or scope of the invention.

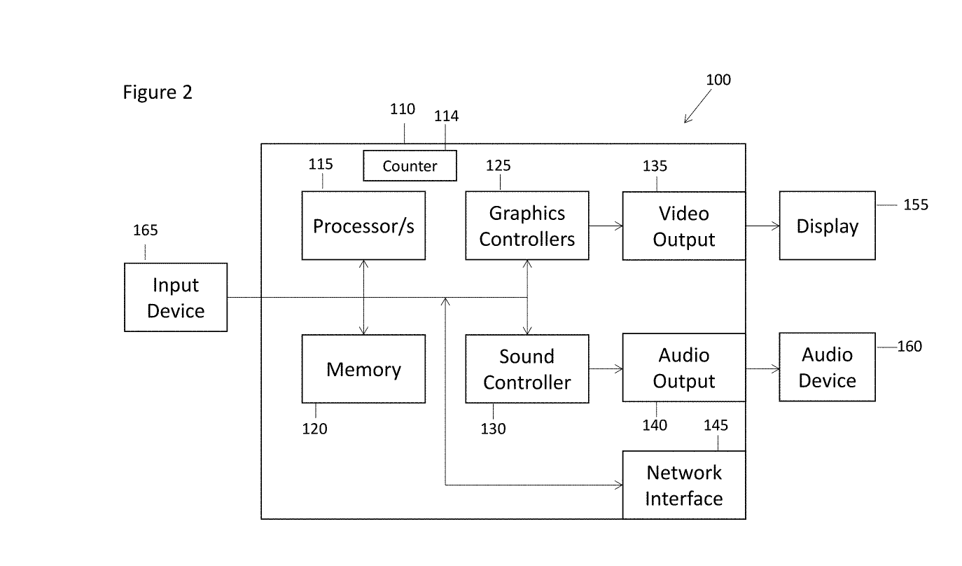

A schematic view of a user device 100 according to an embodiment is shown in FIG. 2. All of the blocks shown are implemented by suitable circuitry. The blocks may be implemented in hardware and/or software. The user device may have a control part 110. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse, touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

The user device has a move counter 114 which will be described in more detail later. The move counter may be implemented in hardware, software, or by a combination thereof. The counter may be implemented by firmware.

It should be appreciated that in some embodiments, the controller may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

The user device may be any suitable computer implemented device. For example the computer implemented device may be a PC, desk top computer, laptop, tablet, smart phone or the like.

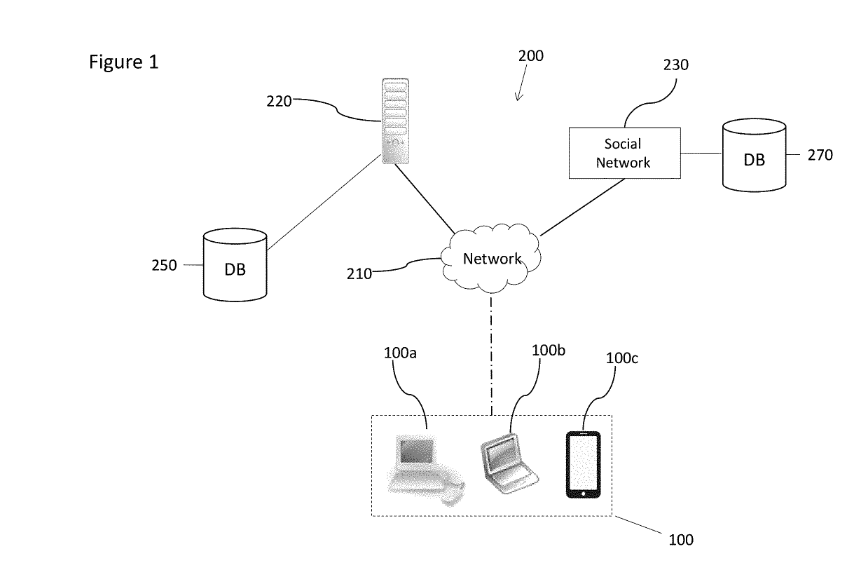

FIG. 1 schematically shows a system 200 according to an embodiment. The system 200 comprises a server 220 which may store or be in communication with database 250 of game player's details, profiles, statistics etc. In practice, one or more databases 250 may be provided. Where more than one server 220 is provided, the database(s) 250 may be provided in one database 250 or across two or more servers. The server 220 may also have a games data function. This may comprise one or more units of memory to store the computer game program, user behaviour data and a processor 115 to run the games program and process the user behaviour data.

The server 220 may communicate via, for instance, the internet 210 to one or more client or user devices 100, shown in FIG. 1 by way of example as user devices 100a, 100b and 100c, and may further provide connections to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 320 may handle some elements of the game in some embodiments. By way of example only, a Java game applet may be provided to the user device 200 and the locally running Java applet will generate, for example, the graphics, sounds, and user interaction for the game play on the user device. Some data may be fed back to the server to allow interaction with other players 305. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

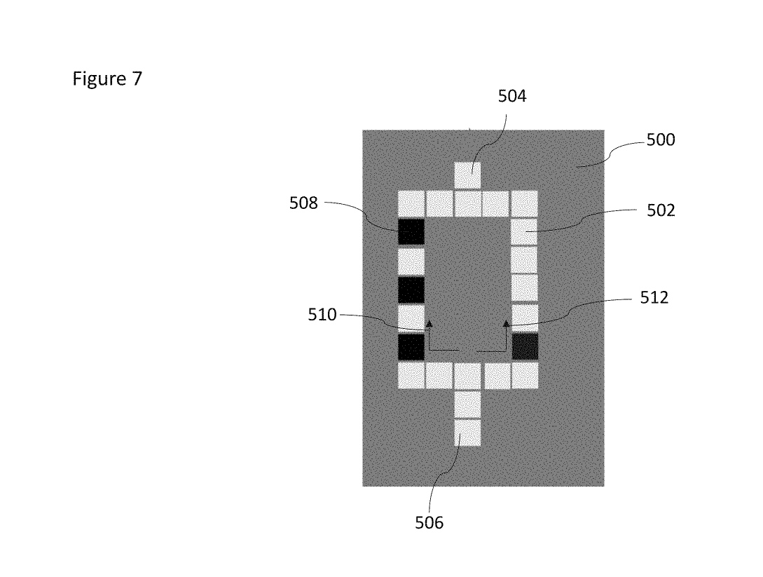

Reference is made to FIG. 7 which schematically shows an example game board 500. The game board is displayed on the display. This is controlled by computer executable code which is run by at least one processor. This game board is by way of example only and many other different game boards may be used in different games or in different game levels. The game board has a start point 506 and an end point 504. A player of the game starts at the start point. The aim of the game may be to get from the start point to the end point. The at least one processor is configured to cause the display of an icon, avatar or any other suitable counter or indicator on the game board to indicate progress of the user with respect to the game board. The game board will be populated with at least one other player. In some embodiments, the at least one other player may be playing the game at the same time or at a different time. Where the other player has previously played the game, the game data stored with that previously played game is replayed on the game board.

In some embodiments, the player may be playing against x other players where x is any suitable integer. In other embodiments, there may not be a fixed number of other players, depending on the criteria used to select the other players.

The game has a defined number of questions associated with a game. For example there may be 10 questions associated with the game. It should be appreciated that there may of course be more or less than 10 questions associated with a game. As mentioned, there may be a number of different game levels available and one or more game levels may have different numbers of questions associated therewith.

A question is displayed on the display and a number of different answer options are displayed. This is under the control of the processor. In some embodiments, four different options are displayed. This is however by way of example only and different numbers of options may be available. In some embodiments, all questions have the same number of options available as answers. In other embodiments, different questions may have different numbers of options available.

A user is prompted to select one of the answers. The prompting of the user may be simply by the display of the question and answer options and/or any other audio and/or visual indication. For example, one or more messages may be displayed. This may be controlled by at least one processor. The user is able to select one of the answers using the user interface. The user is then prompted to select one of the answers which he considers to be the most popular. Depending on what the actual most popular answer is, a number of moves is determined for the user. This is described in more detail later.

After each question, an icon or avatar of the player is moved the determined number of moves with respect to the game board tiles. In some embodiments, it may be the aim to get to the end point 504 before other players. In the example shown, the icon or avatar of the player is able to move from the starting point round the board in the direction of arrow 510 or the direction of arrow 512. In some embodiments, one or more additional functions may be provided by some of the game board tiles. One example of such a game board tile is referenced 508. If a move ends on such a tile, the user may be required to advance or go back a determined number of tiles, go to another particular tile, obtain extra reward and/or the like.

In some embodiments, if the user gets to the end point before other players, then the user may receive a reward such as in-game currency and/or an item which can be given to another user as a gift.

In some embodiments, the answers to the questions are used to determine a degree of matching between using. The matching can be used in social scenarios or for online dating applications. Matching information can be presented in different ways. It may be regarded as a measure of difference and/or a measure of similarity.

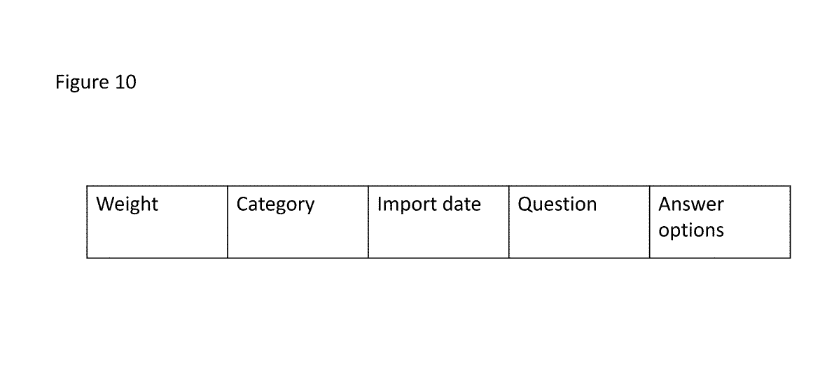

Reference is made to FIG. 10 which schematically shows the set of data associated with a question. This data may be stored in a database at the server side. The data may be provided to the user device. In some embodiments the data may be stored on the user device. The data comprise the question itself and the options for the answers. The data also comprises category information, weight information and the date of import of the question. It should be appreciated that in different embodiments, one or more of these fields may be omitted. In some embodiments, alternatively or additionally, other fields may be provided.

In some embodiments, a relatively large number of different questions are provided so that a user will not keep getting the same set of questions over again.

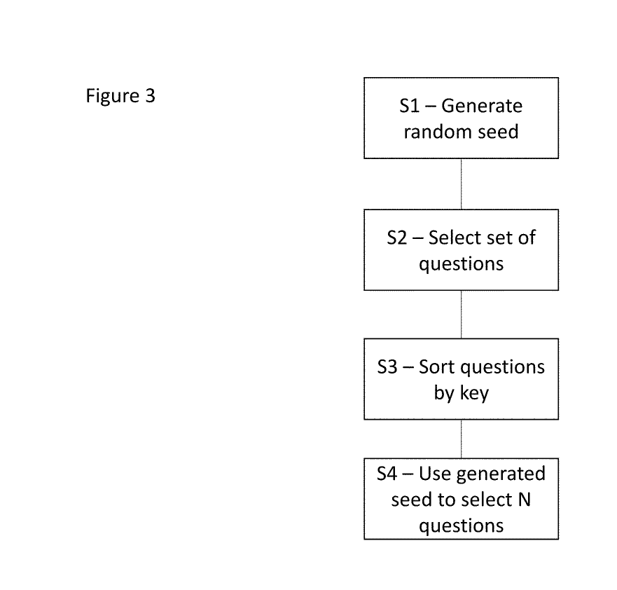

In order to get the questions for a game session reference will now be made to the method flow of FIG. 3.This method may be carried out by a server, by a user device or by the server and user device in combination.

In step S1, a random seed is generated by a random number or pseudo random number generator. This random seed may be within a range of defined seed intervals. In some embodiments the pseudo random number generator may be provided by an algorithm running on a processor. In some embodiments a linear congruential generator (LCG) may be used. LCG is an algorithm that yields a sequence of pseudo-randomized numbers calculated with a discontinuous piecewise linear equation. However, it should be appreciated that any other suitable algorithm may be used.

In step S2, a set of questions is selected from the data store . . . In some embodiments, the set of questions in limited to one or more categories. In some embodiments, the seed is used to identify a seed interval, where each seed interval may correspond to an import date interval. In such scenario the seed may be used to identify the import dates used to filter the questions. Each seed may thus correspond to questions having specific import dates.

In some embodiments, specific categories are associated with specific game boards/levels, and an input by the user causing a specific level to be played may trigger the associated filtration based on category.

The set of questions may be selected based on one or more criteria or filters. For example, the set of questions may be on import date of the questions and/or the category filter. It should be appreciated that some embodiment may take into account the level which a user has reached and/or the number of times a user may have played the game. In some embodiments at least one question may be unique to at least one level. In other embodiments, alternatively or additionally at least one question may be available in at least one or more levels.

In step S3, each question is associated with a key which is used such that the set of selected questions is sorted by key in order to get a deterministic sequence of questions. This may be for example a database index or any other suitable key. This key is unique for that questions. The aim of the filtering process and step S3 is to get a deterministic set of questions for every seed generated in step S1. Thus the sorted selected questions will comprise a subset of K selected questions in a deterministic sequence. Each question is thus given one key that identifies the question.

In step S4, the seed is used in a number generator. Each number output by the number generator is used to select an associated question. The number will be associated with a respective position in the sequence and hence with a question in the deterministic sequence of questions.

In some embodiments, if the output of the number generator does not correspond to a position, that number is discarded and a new number generated. Alternatively a modulo function may be used to provide a number which does correspond to a position in the sequence. Thus in step S4, the seed generated in step S1 is used to generate a sequence of N unique numbers between 1 and K where N is number of questions defined for the level/game board to be played and K is a number of questions in the deterministic sequence that is generated at steps S2-S3.

It should be appreciated that method steps can be performed in any suitable order. For example step S1 can be performed before, after or at the same time as the category filtering in step S2.

In an alternative embodiment, the generated seed number may be used to select a sequence of N questions (of a respective subset) from the respective set of questions.

In some embodiments, replays of a level are selected based on seed number, category filter and number of questions N. That is when a user replays the same level/game board, the randomisation of a seed in step S1 may cause new questions to be posed. The randomised seed may thus map onto a new seed interval and a new set of questions. However, if the seed is the same, the questions would be the same.

Some embodiments may make use of seed intervals.

The seed interval may strictly define the set of questions that will be used in a game session for certain seed. As indicated above the seed interval may be used to filter the questions for example based on import date. It is done by determining which interval the seed belongs to, and based on the specific seed interval so identified for example an associated date interval may be identified. If the seed does not correspond to a seed interval when seed intervals are used a new seed may be generated in step Si. The seed interval may alternatively or additionally be used to control the diversity of the question sets that could be presented to user.

A seed interval is defined as being between a first minimum seed number and a second maximum seed number. Optionally one or more other parameters may be associated with seed interval. For example the parameters may define a minimum and maximum date of question import.

In some embodiments, seed intervals may not overlap.

If a seed interval is replaced with another one that has a different set of questions all replays for these seeds may be removed from database. As the responses to each question is recorded in association with a specific seed, changes to the seed interval or an associated date interval will have an impact on which questions are associated with the seed due to the S2 filtering process. Thus old recorded responses to a seed may not correlate to the questions associated with a new seed interval which the same seed number subsequently may fall into following a change

In some embodiments, the categories may comprise one or more of:

Relationships: Relationship related questions.

Interests: Interests and Hobby related questions

Lifestyle: Lifestyle related questions.

Character: Personality and Attitude related questions

Dislikes: Questions about what is for example disliked more.

Humour: Humourous questions.

In some embodiments one or more other parameters may be associated with the question in addition or in the alternative. The one or more other parameters may additionally or alternatively be used to filter the questions.

In some embodiments, the number of questions which is provided in each category may be the same or different. For example, the categories which are considered to be more useful in achieving a particular type of match may have more questions. This information may be stored in a data store such as a database and/or a memory of the user device.

In another embodiment, the categories may each have a weight or may considered to have an equal weighting. In some embodiments, the different categories may have different weights. The weight will determine the number of questions from that category.

In the example shown below, the total number of available questions is 1000. The number of questions to be selected is 10 so the weight is expressed as the number of questions out of that 10 which are to come from each category. Of course the number of available questions may be more or less than 100. The number of questions N to be selected may be more or less than 10. The weight may be expressed in other suitable ways such as a percentage or a fraction of 1.

| Category | Size (number of questions) | Weight |
|---|---|---|
| Relationship | 150 | 2-3 |
| Interests | 250 | 2 |
| Lifestyle | 200 | 2-3 |
| Character | 200 | 2-3 |
| Dislikes | 100 | 1 |
| Humour | 100 | 1 |

### Weighting of Questions

In the following each question i has a weight of importance wi from 0 to n associated therewith. Each question will have a plurality of different options which are presented as possible answer options. Each option j of the question i has a respective integer descriptor oi,j which reflects relative similarity between options. It should be appreciated that this data may be stored in a suitable data store such as a database and/or a memory of the user device.

For example the question “How many hours of sleep do you need?” might be considered to be important and have a weight w=80 out of 100. The weighting values can be defined according to any suitable scheme, for example out of 100, a value between 0 and 1 or one of set of possible discrete values.

The options for answers for this question is shown in the first column and the respective values of the integer descriptor are shown in the table below.

| Option | Descriptor |
|---|---|
| 3-5 hours | 7 |
| 5-8 hours | 5 |
| 8-12 hours | 3 |
| 12+ hours | 1 |

diff(Oₐ,O_{b}) is defined as a function that computes relative difference as a real number between 0 and 1 for options a and b respectively. Options a and b are two possible answers to a question. For example if user A answers 8-12 hours and user B answers 5 to 8 hours then Diff(Oₐ,O_{b}) may be 5−3=2. (In some embodiments, the difference may always be expressed as a positive number but not necessarily).

In some embodiments a distance between two users A and B that answered the same set of questions from 0 to n is calculated as geometrical distance

$${dist}_{abs} = \sqrt{{\sum }_{i = 0}^{n} {( {w}_{i} * diff ( {o}_{A} , {o}_{B} ) )}^{2}}$$

Diff(O_{A},O_{B}) is the relative difference between the option selected by User A and the option selected by User B. wᵢ is the weight of question i. n is the number of questions.

The maximum absolute distance may be defined as

$${dist}_{max} = \sqrt{{\sum }_{i = 0}^{n} {( {w}_{i} )}^{2}}$$

The relative distance is

$${dist}_{rel} = \frac{{dist}_{abs}}{{dist}_{max}}$$

The match in percentage terms between User A and B may be then defined as:

match=(1−distᵣₑₗ)*100

It should be appreciated that the general distance can be determined in any suitable way.

For example, in some embodiments, the general distance is calculated using an arithmetic mean case.

In this case distance between for users A and B that answered the same set of questions from 0 to n is calculated as an arithmetic mean as follows

$${dist}_{abs} = \frac{{\sum }_{i = 0}^{n} {w}_{i} * diff ( {o}_{A} , {o}_{B} )}{n}$$

The maximum absolute distance is the result of

$${dist}_{max} = \frac{{\sum }_{i = 0}^{n} {w}_{i}}{n}$$

In other embodiments, distance between for users A and B that answered the same set of questions from 0 to n is calculated as geometrical distance.

$${dist}_{abs} = \sqrt[n]{{\prod }_{i = 0}^{n} ( {w}_{i} * diff ( {o}_{A} , {o}_{B} ) )}$$

The geometric mean of a data set {a₁, a₂, . . . , aₙ} is given by:

$${( {\prod }_{i = 1}^{n} {a}_{i} )}^{1 / n} = \sqrt[n]{{a}_{1} {a}_{2} … {a}_{n}} .$$

In this case, a is defined for each question as w*Diff(O_{A},O_{B})

The maximum absolute distance is the result of

$${dist}_{max} = \sqrt[n]{{\prod }_{i = 0}^{n} {w}_{i}}$$

It should be appreciated that in some embodiments, a different difference function could be provided depending on the type of question. For example categorical questions may have a different function to ordinal questions.

In ordinal questions, the number assigned to the answer category has meaning. The answer categories can be ranked from highest to lowest (or lowest to highest). Categorical data may assign numbers to represent different categories of answers. For example, the value “1” is assigned to male and the value “2” is assigned to female. These numbers do not represent anything meaningful.

For example, categorical questions may use the following function.

diff_{cal}(O_{A},O_{B})=(O_{A}==O_{B})?0:1

For example, ordinal questions may use the following function.

diff_{cal}(O_{A},O_{B})=\sqrt{(O_{A}−O_{B})²}

In some embodiments, the match percentage is calculated for each category of questions by formula.

$${dist}_{weighted} = {\sum }_{i = 0}^{n} \frac{{w}_{i} * diff ( {o}_{A} , {o}_{B} )}{diff ( {o}_{min} , {o}_{max} )}$$

$$2 § match = ( 1 - \frac{{dist}_{weighted}}{{\sum }_{i = 0}^{n} {w}_{i}} ) * 100$$

It should be appreciated that these equations may be performed by a computer program comprising computer executable instructions stored in memory and running on at least one processor.

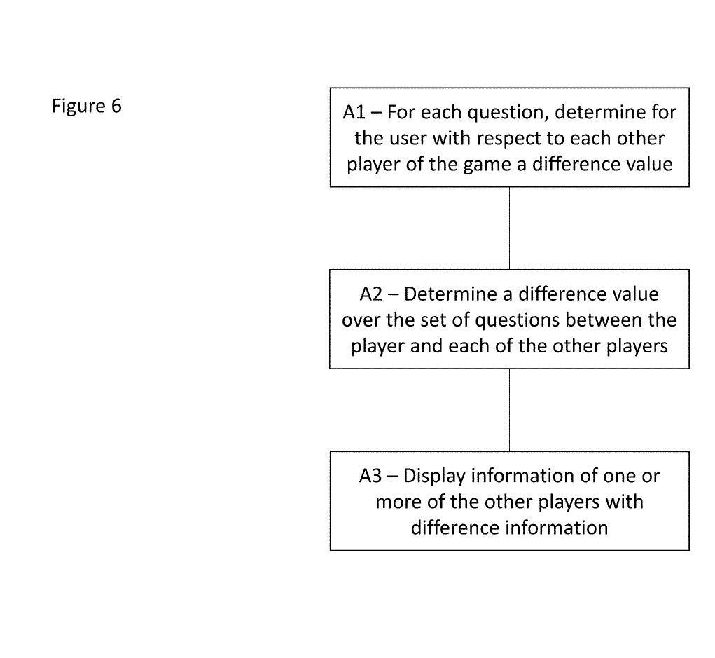

Reference is made to FIG. 6 which a shows a flow of an embodiment. This may be performed in a user device in some embodiments.

In step A1, for each question of the set of questions, it is determined for the user with respect to each other player of that game a respective difference value. These may be any of the values as previously discussed.

In step A2, a difference value is determined over the full set of questions for the user with respect to each other player. This resulting difference value may be based on the determined difference values determined in step A1. This may be as previously described.

In step A3, information on one or more of the other players may be displayed. The information may comprise identity information. The identity information may take the form of an avatar and/or name information which is used by the other player in the game.

The resulting difference information can take any suitable form as previously described and may for example be in the form of a percentage or similar value. Information associated with that difference value may be displayed.

The information on the difference value may be considered to provide information defining the degree of difference or the degree of similarity. In some embodiments the information on the difference value may comprise match information.

In some embodiments, a subset of one or more of the other players is displayed. These may be the subset of players which are considered most similar and/or least similar. For example, where the percentage of similarity is represented by a higher percentage value, the subset of one or more other players with the highest percentage value(s) may be displayed.

Alternatively, the user may be able to scroll through all the other players in the game. In this embodiment, the other players may for example be ordered in dependence on the degree of match with the user.

In some embodiments, the other players are displayed in a list ordered in dependence on the match information. The list may not necessary include all of the other users but may only include a subset thereof. The subset may be based on any suitable criteria.

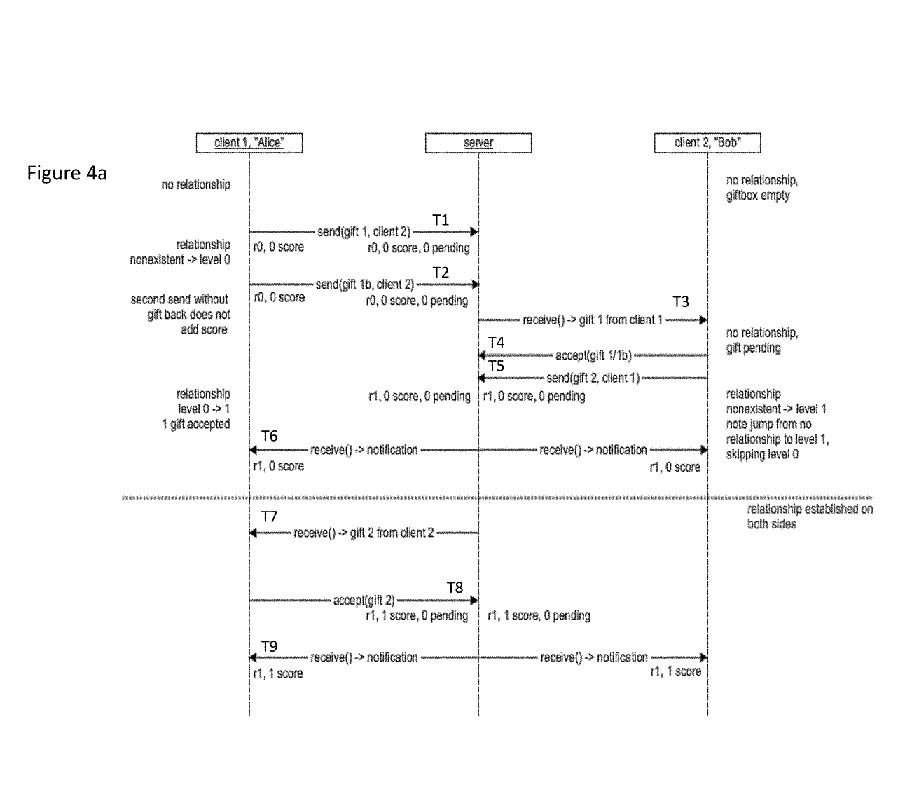

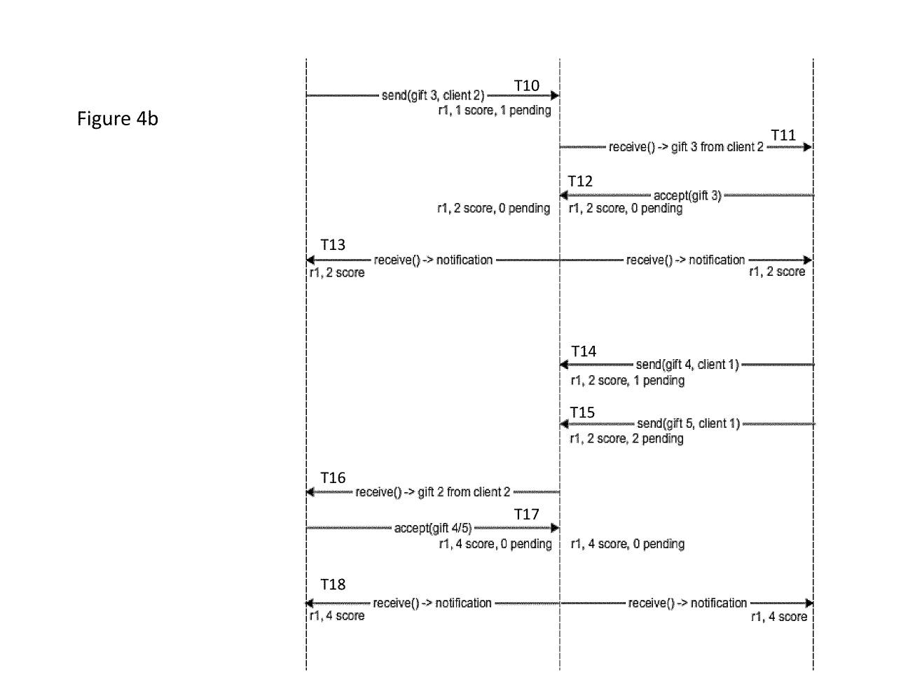

Reference is made to FIGS. 4a and 4b which show a method flow. The steps of FIG. 4a are followed by the steps of FIG. 4b. FIGS. 4a and 4b show first device, a second device and a server and the communication there between. The first device is referred to a client 1 “Alice”. The first device is a user device such as described in relation to FIG. 1. A user (Alice) is configured to interact with the user interface. The device will be running a game which is associated with the account of Alice. The second device is referred to a client 2 “Bob”. The second device is a user device such as described in relation to FIG. 1. A user (Bob) is configured to interact with the user interface. The device will be running a game which is associated with the account of Bob.

Initially, there is no relationship between Alice and Bob. In other words, they are not connected in any way and there are no pending requests to connect.

In the following various messages are sent between the first device and the server and between the second device and the server. The message will be formulated by the at least one processor of the device/server and transmitted thereby. In the case of the first and second devices the messages may be formulated in response to user input received via a respective user interface. It should be appreciated that the messages will be received by a respective receiver of the device or server.

In step T1, the first device sends a message to the server. This may for example be at the end of game where a subset of one or more other users are displayed on the device. The user may want to start communication with one of the other players displayed in as part of the subset. This message will comprise a gift and/or an indication that a connection is requested. It should be appreciated that this message will indicate a particular recipient of the request for a connection or a gift. In this example, the recipient is Bob. It should be appreciated that a gift may comprise one or more items usable when Bob is playing the game via his user device. Of course the items are not physically sent but information defining the gift will be sent such that the recipient computer game code is able to provide the required item in the game. In order to send a gift, the gift may have been purchased using either in game currency or real currency. It should be appreciated by playing the game, in game currency may be acquired by the player of the game which may be used to provide a gift to another user. In some embodiments, playing the game may earn items which can be provided as gifts to another player.

It should be appreciated that as a result of step T1, the relationship between Alice and Bob has changed from non-existent to zero. The relationship parameter is measure of whether or not there is any connection between the two users. In this embodiment, there is a non-existent relationship level, a level (0) where the one party is attempting to connect to another party and a level (1) where the parties are connected to one another. It should be appreciated that the number of levels of the relationships may be more or less than three. It should be appreciated that in other embodiments, the value of the relationship parameter may be expressed differently. For example the relationship parameter may not have a numeric value. It should be appreciated that the server is configured such that data about any relationship between any two or more peoples is stored in the database. Information about relationships which a user of a device has may be locally stored on the user device.

In step T2, the first device is caused by interaction with the user interface by Alice to resend a gift or connection request to the second user device in a second or to send a new gift or connection request. It should be appreciated that this second message, without receiving any response from the second user device will not change the relationship score.

In step T3, the server will send a message to the user device associated with Bob which includes the first gift or connection request. Effectively, the server is sending the message from the first user device. It should be appreciated that the message may be unchanged or may be reformatted by the server. The server may add and/or remove information from the message.

The second device, in response to input from Bob via the user interface will accept the gift. At least one processor of the client device is configured, to cause a response to be sent to the server which accepts the request or gift. This is carried out in step T4.

In step T5, the user associated with the second device will, via the user interface, select the option of sending for example a gift back to the user of the first device. This message is sent to the server. This may be as described in relation to step T1. In some embodiments, steps T4 and T5 may be combined.

It should be appreciated that after receiving the request in step T3, there is no relationship between Alice and Bob as the gift or connection request from the first device is pending. However, after the gift has been sent, the relationship changes from the non-existent to level 1. It should be appreciated that the level changes from no relationship to level 1, skipping level 0.

In step T6, the server sends a notification to each of the first and second devices indicating that the relationship level has gone up to level one. It should be appreciated that the acceptance of the gift or request will change the relationship level from 0 to 1 in the case of the first device.

As indicated by the dotted line in FIG. 4a, a relationship between the Alice and Bob has been established.

At step T7, the server sends the message with the gift information, which was from the second device, to the first device. This may generally be as discussed in relation to step T2.

In step T8, the first device accepts the gift. The relationship score for the first device is one. There is also a measure of the number of completed exchanges. A completed exchange is where one party has sent a first message (for example containing a gift) to which the other party has responded (for example by accepting the gift). This is referred to as a score. In this example the score is now 1. A number of incomplete exchanges where is a given party has initiated an exchange but has not yet received a reply is also maintained. In this example, there are no incomplete exchanges pending. It should be appreciated that this is only one example in which the communications between the first and device can be recorded. This may be useful in determining a degree of match.

In the step T9, both of the first device and the second device are sent a notification which advises both the first device and the second device of the increase of the score from 0 to 1.

Reference is now made to FIG. 4b which continues the method flow of FIG. 4a. In step T10, the first device sends a message to the server with another gift for the second device. There is now 1 pending exchange.

In step T11, the server sends a message with that gift to the second device in step T11.

In step T12, the second device accepts the second gift. In this case, the score is increased from 1 to 2.

In step T13, the server advises the first device and the second device of the updated score.

In step T14, the second user device sends another message with a further gift to the server. This is followed in step T15 by a second further gift being sent from the second device to the server.

In step T16, the first user device receives the two gifts from the second user device.

In step T17, the two gifts from the second user are accepted by the first user. The score is then changed from 2 to 4.

In step T18, the server is configured to advise both the first device and the second device of the updated score.

It should be appreciated that the score is a measure of the relationship. This may be used in some embodiments. For example a higher score/relationship level may open up new means of interacting with each other, for example being able to send emoticons, send pre-defined text messages and ultimately allow chat with each other.

In some embodiments a higher score is indicative of a higher amount of contact. In some embodiments, the contacts of a user may be displayed. In some embodiments, the contacts may be ordered by score. In some embodiments, the contacts which are displayed may be dependent on the core.

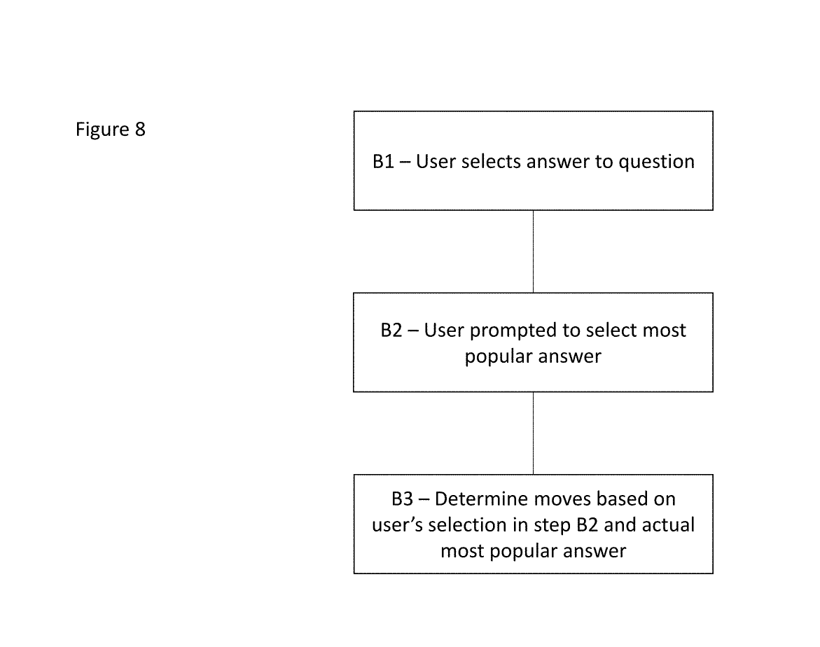

As mentioned previously, the player's input via the user interface will control the number of tiles by which the avatar or icon of the user on the game board moves after each question. In this regard, reference is made to FIG. 8.

In step B1, the question and available answer options are displayed. The user will select via the user interface one of the answers to the question.

In step B2, the question and same answer options are displayed and this time the user is prompted to it to select which is the most popular answer with the other players. In other embodiments, the criteria which the user is asked to use to base their selection on may of course be different. For example the user may be asked to predict the least popular answer or what a particular user has selected to guess which is the correct answer.

In step B3, the at least one processor determines the number of moves based on the user's selection as to the most popular answer and the actual most popular answer. In this regard, reference is made to the previous example which was for the question “how many hours of sleep do you need”. Each of the options provided has a descriptor. Accordingly, in one embodiment, the difference between the user selected answer and the most popular answer is determined. Based on the difference, this will control the number of moves. For example, in some embodiments, if the difference is zero, the user can move 2 tiles forward. If the difference is positive, then the user can move one tile forward or if the difference is negative, the user can move one tile backwards. It should be appreciated that any suitable algorithm may be used for determining whether or not the user can move and if so by how many tiles.

In some embodiments, step B2 may be omitted and the number of moves may be determined based on the user's selection on the one hand and the answer which satisfies the criteria or which is randomly selected 8 on the other hand

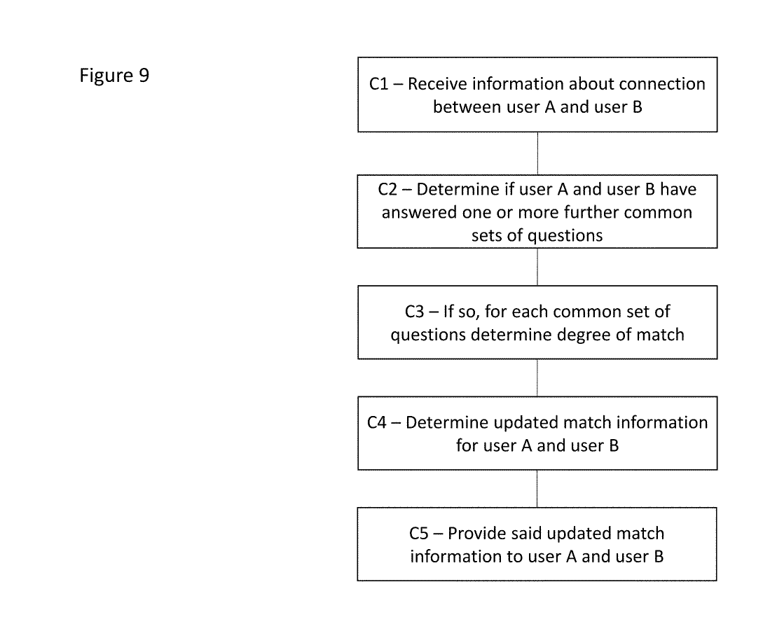

Reference is made to FIG. 9. This may be carried after an initial match value has been determined for two players and they have become connected in order to provide an updated match value. Alternatively this may be carried out when the two users connect but do not have a match value.

In step C1, when the two users are connected, for example as described in relation to FIGS. 4a and 4b, information about the connection between the two users may be received by the server. The server may receive that information as part of the message exchange between user A and user B. The server will maintain a database. In that database, for each user, a record will be kept of:

every other user to which that user is connected and for each of those other users the relationship status and score; information on all of the game seeds used by that particular user; and information on the answers associated with each game seed.

In step C2, a determination is made at the server if the user A and user B have answered the same set of questions. For example, when the server determines that users A and B have connected, it will compare the seed(s) associated with user A and the seeds associated with user B. If any of the seeds are the same, the server will assume that users A and B have answered the same set of questions associated with the respective seeds.

In step C3, the server will then for each common set of questions determine the degree of match. This may be defined using the difference measures as described previously. Thus, the degree of match for each common set of questions will be determined. This may be using any of the previously described techniques.

Based on these determinations, in step C4, updated match information is determined for user A and user B. This information is of course stored in the database.

In step C5, the server provides the updated match information to user A and user B. In this way, a more detailed match analysis can be carried out.

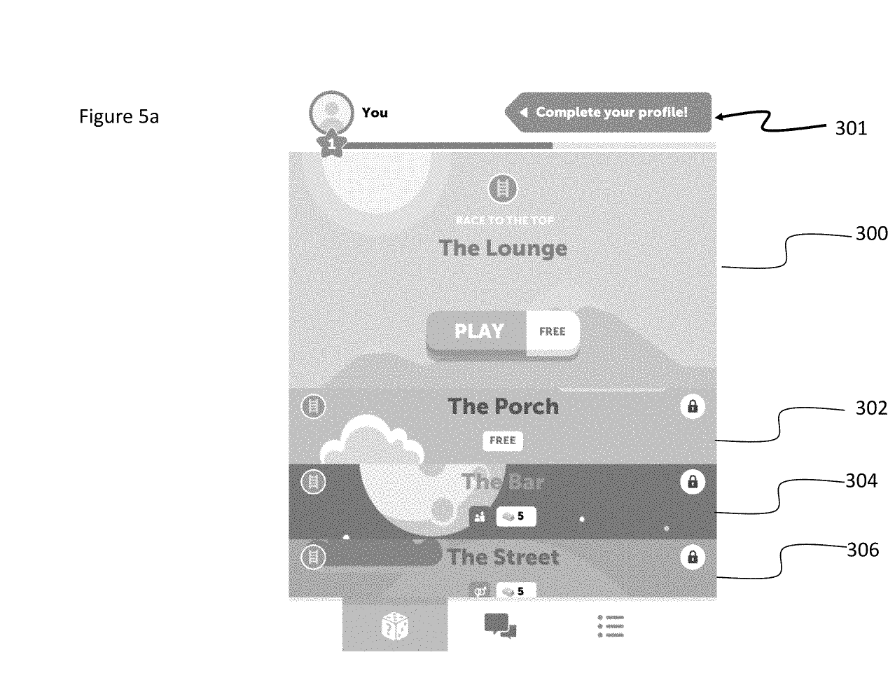

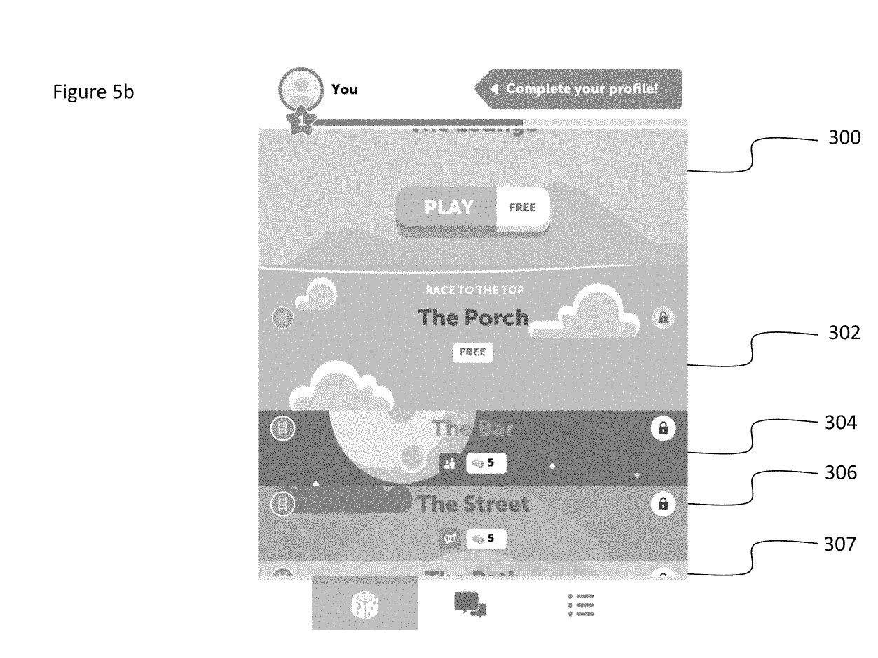

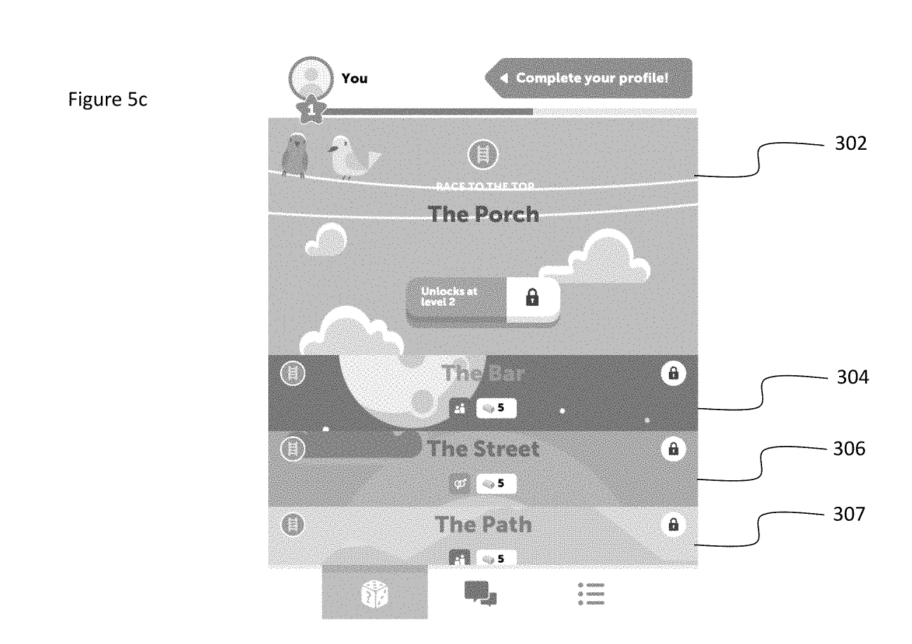

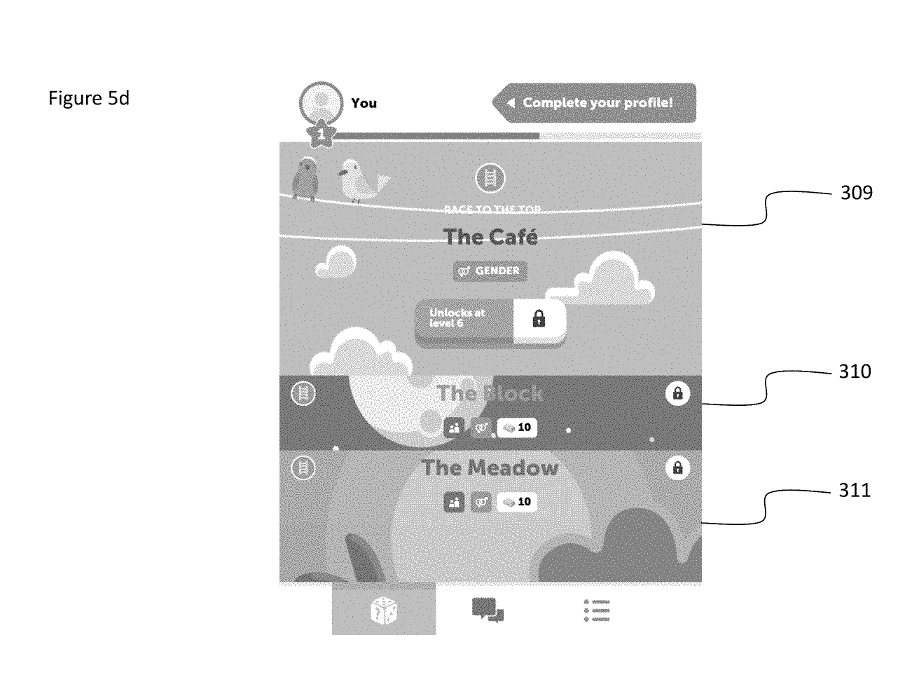

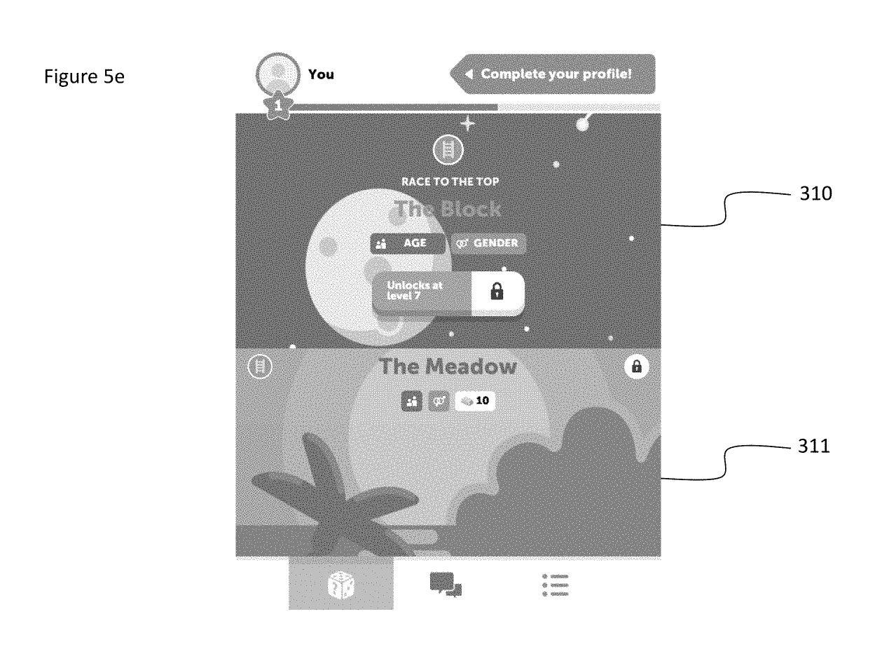

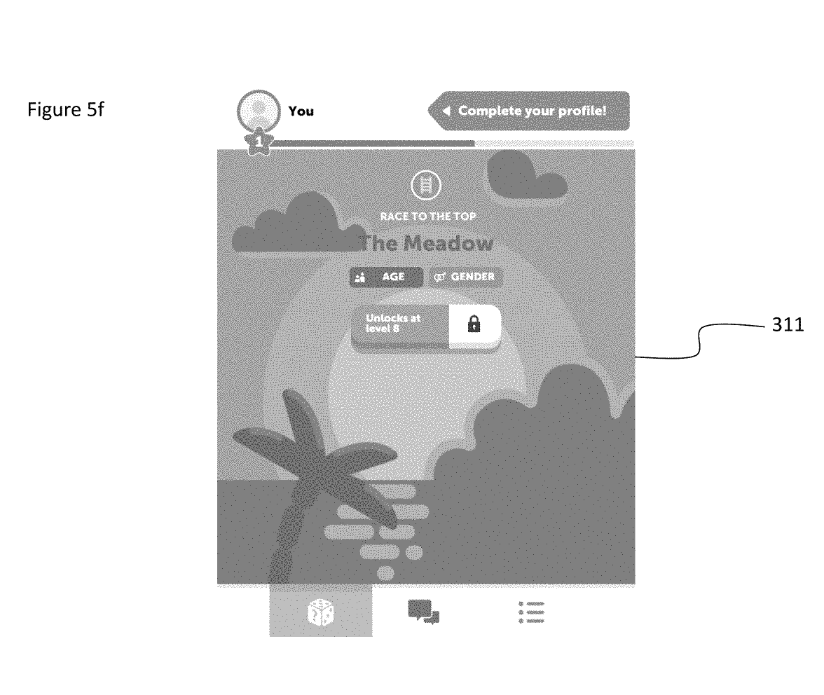

References made to FIGS. 5a to 5f which show an image which is displayed in some of the embodiments. In some embodiments of the game, there are a plurality of different levels. In some embodiments, a user has to complete one level before the user is able to progress to the next level. In other embodiments, the levels may be regarded as a list of different individually selectable levels, regardless of whether or not a user has played a preceding level.

Some of the embodiments may be designed to be played on a relatively small device such as a tablet or a smartphone. Some embodiments may be designed to be played with a relatively large number of levels. Both of these requirements (either individually or together) may make the selecting and viewing of the levels difficult. Accordingly, in some embodiments, only a subset of the levels are displayed at any one time.

Referring first to FIG. 5a, this shows an initial display of some of the different levels. The first level 300 is considered to be the first level of the list. This is followed by level 302, 304, and 306. It should be appreciated that there are further levels after level 306, but which are not displayed. The level which is at the top of the list, level 300, has a larger area displayed. This is because this area additionally includes further information associated with that level, which is hidden for the other levels displayed in FIG. 5a. In this example, the initial level may also have a selectable area which when selected allows the level to be played. Optionally, the area for the first level may include information about the game objective associated with that particular level.

In embodiments, the user is able to scroll through the list of levels. It should be appreciated that in some embodiments, this may be done using a pointer device such as a cursor interacting with the display. In other, touch screen-based embodiments, this scrolling through the list of levels may be achieved by the user moving their finger up and down the display.

Reference is now made to FIG. 5b which shows the view after the user has achieved some scrolling through the list. As can be seen, the area associated with the first level 300 has become smaller and part of the information which was visible in FIG. 5a is no longer visible. However, the area available for the next option or level 302 is becoming larger and more information about that level is being displayed. Additionally, as the user scrolls through, a further level 307 starts to be visible.

Reference is made to FIG. 5c which shows the second level at the top of the list and with all of the information about the second level displayed. The first level is no longer displayed in the list. More of the fifth level 307 is being displayed. In this way, the user can continue to scroll through the list. FIGS. 5d to 5f will now be described as they show views displayed by the user device as the user gets to the end of the list. In the example shown in FIG. 5d, level 309, 310, and 311 are displayed. Level 311 is the last of the available levels. Level 309 is at the top of the display, and as such all of the information about level 309 is displayed, such as previously described.

However, as there is no further level after level 311, the remaining space on the display is occupied by an increasingly larger area associated with level 311.

FIG. 5e shows the case where the second to last level 310 is fully displayed at the top of the list, as previously described and the remaining part of the display is occupied by the final level. It should be appreciated that although a larger area is available for the last level 311, none of the further information available is displayed at this time. Of course, in other embodiments, additional information may be displayed for the second to last and last levels at the same time.

In FIG. 5f, when the user reaches the end of the list, the entire screen is used to display information associated with the final level, level 311.

In some embodiments, a given number of players may be selected for the user to play against. That number may be any suitable number. For example the total number of players may be 100. However this is by way of example only and in different embodiments, different number of players may play. The number of players playing a game may vary between games and/or between different game levels or options.

In some embodiments, the other players may have already played the game and accordingly their game data may be used when then player is playing to provide a “live” experience. For example, these other players may have played the same game associated with a particular game seed.

In some embodiments, one or more filters may be provided to select the other players. Examples of one or filters comprise an age filter, a gender filter and a country filter. This may be selected by a player of the game or may be selected by the computer program based on associated parameters of the player. The player may for example select one or more of the preferred age range of the other players, the preferred gender of the other players and the preferred country of the other players.

The answers and data about other users are retrieved for select players playing the same seed only and by filtering the data of users using the above filters. By calculating the relative distance calculated between a players answers and the filtered other players, it is possible to achieve more relevant matches for the player in regards to the other players which they may wish to interact with.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

A person skilled in the art will realise that the different approaches to implementing the game is not exhaustive, what is described herein are certain preferred embodiments. It is possible to implement the way in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer device comprising:
at least one memory configured to store computer code;
a display;
at least one processor configured to execute said stored computer code to cause said display to display part of a list of different game options for a computer implemented game, each game option when selected allowing a game to be played; and
a user interface configured to receive input from a user to scroll through said list displayed on said display,
wherein, responsive to said user input scrolling through said list of different game options, the at least one processor is configured to cause the display to display one of said different game options in a game option area which is at a predetermined position with respect to said display with a larger area than at least one other game option area associated with a respective different one of said different game options.

2. A computer device as claimed in claim 1, wherein the game options comprise game levels.

3. A computer device as claimed in claim 1, wherein when said one of the game options is at the predetermined position with said larger area and input is received from said user interface, the at least one processor is configured to cause said one game option to be selected.

4. A computer device as claimed in claim 1, wherein when a game option is displayed at the game option area with the larger area, the at least one processor is configured to cause the display to display additional information as compared to said at least one other game option area.

5. A computer device as claimed in claim 4, wherein the additional information comprises one or more of :
information about said game option; and an area selectable using the user interface, said selectable area when selected causing the game option to be played.

6. A computer device as claimed in claim 1, wherein the at least one processor is configured to control the display such that a game option area increases as the input from the user interface causes that game option area to moves to the predetermined position with respect to the display.

7. A computer device as claimed in claim 1, wherein the at least one processor is configured to control the display such that a game option area decreases in size as the input from the user interface causes that game option area to move away from the predetermined position with respect to the display.

8. A computer device as claimed in claim 1, wherein each of said game option areas which is fully displayed on said display is of at least a minimum size.

9. A computer device as claimed in claim 8, wherein said at least one processor is configured to control the display such that a game option area increases from the minimum size as the input from the user interface causes that game option area to moves to the predetermined position with respect to the display.

10. A computer device as claimed in claim 1, wherein said at least one processor is configured to control the display such that said predetermined position is at a top region of said display.

11. A computer device as claimed in claim 8, wherein said at least one processor is configured to display at least one other game option other than the last game option and the last game option, said last game option when fully displayed on said display having a size between said minimum size and a size which is defined by a size of said game object area less the larger area.

12. A computer device as claimed in claim 1, wherein said at least one processor is configured to display said list extending in a first extent of said display, said user input configured to receive said input from a user to scroll along said first extent through said list displayed on said display.

13. A computer device as claimed in claim 1, wherein said display is configured to display a subset of said different game options at one time.

14. A computer implemented method for displaying, on a display, computer game graphics for a computer implemented game, comprising executing on one or more processors the steps of:
causing said display to display part of a list of different game options for a computer implemented game, each game option when selected allowing a game to be played;
receiving input from a user via a user interface to scroll through said list displayed on said display; and
responsive to said user input scrolling through said list of different game options, causing the display to display one of said different game options in a game option area which is at a predetermined position with respect to said display with a larger area than at least one other game option area associated with a respective different one of said different game options.

15. A computer implemented method as claimed in claim 14, wherein when said one of the game options is at the predetermined position with said larger area and input is received from said user interface, the method comprises causing said one game option to be selected.

16. A computer implemented method as claimed in claim 14, wherein when a game option is displayed at the game option area with the larger area, the method comprises causing the display to display additional information as compared to said at least one other game option area.

17. A computer implemented method as claimed in claim 16, wherein the additional information comprises one or more of:
information about said game option; and an area selectable using the user interface, said selectable area when selected causing the game option to be played.

18. A computer implemented method as claimed in claim 14, comprising controlling the display such that a game option area increases as the input from the user interface causes that game option area to moves to the predetermined position with respect to the display.

19. A computer implemented method as claimed in claim 18, comprising controlling the display such that a game option area decreases in size as the input from the user interface causes that game option area to move away from the predetermined position with respect to the display.

20. A non-transitory computer readable medium encoded with instructions for controlling a computer device having a display, in which the instructions when executed on a processor enable the processor to execute the steps of:
causing said display to display part of a list of different game options for a computer implemented game, each game option when selected allowing a game to be played;
receiving input from a user via a user interface to scroll through said list displayed on said display; and
responsive to said user input scrolling through said list of different game options, causing the display to display one of said different game options in a game option area which is at a predetermined position with respect to said display with a larger area than at least one other game option area associated with a respective different one of said different game options.
